(19) United States
(12) Patent Application Publication
(10) Pub. No.: US 2025/0298914 A1
(43) Pub. Date: Sep. 25, 2025

(54) INTEGRATED DEVELOPMENT ENVIRONMENT WITH PERMISSION-BASED CODE MANAGEMENT

(71) Applicant: Zoho Corporation Private Limited, Kanchipuram District (IN)

(72) Inventors: Pradeep Kumar Duraisamy Soundrapandian, Sivakasi (IN); Punithavathi Palani, Chennai (IN); Subathra Periakaruppan, Madurai (IN); Sridhar Vembu, Tenkasi (IN); Joseph Sathya Kumar, Chennai (IN); Akshhayaa S, Guduvanchery (IN); Sudheer A. Grandhi, Pleasanton, CA (US)

(73) Assignee: Zoho Corporation Private Limited, Kanchipuram District (IN)

(21) Appl. No.: 19/074,360

(22) Filed: Mar. 8, 2025

Related U.S. Application Data
(60) Provisional application No. 63/640,893, filed on May 1, 2024.
(60) Provisional application No. 63/668,253, filed on Jul. 7, 2024.

(30) Foreign Application Priority Data
Mar. 20, 2024 (IN) 202441021146
May 23, 2024 (IN) 202441040275

(51) Int. Cl. G06F 21/62; G06F 8/33

(52) U.S. Cl. CPC G06F 21/6209; G06F 8/33; G06F 2221/2141

(57) ABSTRACT

A distributed Integrated Development Environment (IDE) allows for multiple users with varying levels of permissions to collaborate on a software development project and to perform operations within the environment based on permission levels for those specific operations. An IDE-directed keyword may be inserted into source code to identify constructs for which a permission is required to perform an operation associated therewith. Permission requirements may be defined based on a type of construct, or an inherent property of a construct. Permissions are assigned for various operations, with IDE directive keywords, or assigned by code constructs or context. When a permission requiring event is triggered, user permission is checked, and a workflow for the operation is executed. A workflow may include executing the operation or denying execution of the operation. Errors, warnings, messages to team members, event logging, code synchronization, permission requests, and other actions may be incorporated in workflows.

### CROSS REFERENCE TO RELATED APPLICATIONS

This application is related to Indian Provisional Application 20/244,1021146 filed 30 Mar. 2024, and U.S. Provisional Application 63/630,893 filed 1 May 2024, both entitled “WORKFLOW MANAGEMENT SYSTEM FOR LINK TYPE OBJECT MANAGEMENT”, and Indian Provisional Application 20/244,1040275 filed 23 May 2024, entitled “INTEGRATED DEVELOPMENT ENVIRONMENT WITH PERMISSION-BASED CODE MANAGEMENT”, all of which are incorporated herein by reference.

### FIELD OF THE INVENTION

Embodiments of the present disclosure are related, in general, to computer programming languages and more particularly, but not exclusively, to software development environments.

### BACKGROUND

Modern Integrated Development Environments (IDEs) and compiler systems are sophisticated tools that have revolutionized the way developers create, test, and deploy software. They are designed to streamline the development process, making it more efficient and less error prone.

An IDE is a software suite that consolidates the basic tools needed to write and test software. Modern IDEs come with a source-code editor, build-automation tools, and a debugger. Some also include features like intelligent code completion, syntax highlighting, and code refactoring, which help developers write clean, efficient code. They often support multiple programming languages and provide a unified interface for developers to write, compile, debug, and run their code.

Compiler systems transform the source code written by developers into executable programs. Modern compilers do more than just translate code from one language to another. They also optimize the code to make the resulting program run more efficiently including support for multiple target platforms with different operating systems or hardware architectures. They often come with extensive debugging and profiling tools. These tools help developers identify and fix performance bottlenecks in their code, making it easier to create efficient, high-performance software.

One of the defining characteristics of modern IDEs is their extensibility. They often come with plugin systems that allow developers to add new features or support for additional programming languages. This extensibility makes them adaptable to a wide range of development needs. Furthermore, many IDEs offer cloud-based versions, enabling developers to work from anywhere and collaborate with others in real-time.

At the source code level, user-defined types pertain to structures, classes, interfaces, and other composite data types that programmers define to represent and manipulate complex data structures more effectively. These types go beyond the basic data types like int, float, and char that most languages offer inherently. User-defined types allow for the encapsulation of data and related functionality into cohesive units. At compile time, the compiler checks these types for syntactic and semantic correctness. This includes ensuring that the members of a class or structure are correctly defined, that methods are properly declared and implemented, and that any inheritance or interface implementation is correctly specified. The primary goal during this phase is to ensure that the code adheres to the language's syntax and semantics, and if it doesn't, to provide meaningful feedback to the developer.

In a distributed IDE with multiple users of varying position and skill levels developing software incorporating complex data structures, it is desirable to have IDE management functions to facilitate identification of best practices and workflows for a variety of coding activities.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 is a distributed Integrated Development Environment (IDE).

FIG. 2 is a flowchart 200 illustrating a method of workflow, operation, and permissions management in a distributed IDE.

FIG. 3 conceptually illustrates an embodiment of an Abstract Syntax Tree (AST) 140 configured for marking source code for permission requirements.

FIG. 4 illustrates a local IDE environment 106 interacting with project server 120 in a distributed IDE environment.

FIG. 5 is a flowchart 500 illustrating an example workflow for generation of a draft event handler for auto-suggestion and permission-based editing and incorporating the draft into source code.

FIG. 6 is an illustration of an example dashboard 111 for managing user permissions.

FIG. 7 is a flowchart 700 illustrating modifying a user permission for an IDE operation.

FIG. 8 illustrates an example embodiment of distributed IDE 100 including components of a user terminal 104 and a project server 120.

### DETAILED DESCRIPTION

A distributed IDE is provided that allows for multiple users with varying levels of permissions to collaborate on a software development project and to perform operations within the environment based on permission levels for those specific operations. An IDE directed keyword may be inserted into source code to identify a construct or constructs for which a permission is required to perform an operation associated with the construct. Permission requirements may also be defined based on a type of construct, or an inherent property of a construct.

A workflow is a predefined sequence of tasks or actions that automate and streamline processes to achieve specific goals. It defines the logical flow of actions, decisions, and conditions within a system. A trigger is an event or condition that initiates a workflow, serving as the catalyst for automated processes.

Configuring a workflow involves designing the sequence of tasks, actions, and decisions. This process may be carried out by individuals or teams with expertise in process design, automation, and a specific workflow tool being used. In the context of a software development scenario, an IDE may be configured such that a trigger might be set up to automatically alert a project leader based on specific conditions, such as using code not conforming with defined best practices code for the project. The project leader plays an important role in configuring and overseeing the workflow to ensure efficient and consistent task execution.

A trigger in the IDE may include any input from a user, examples include text editing, mouse/trackpad inputs, voice commands, and the like. Various IDE trigger operations associated with source code include viewing, adding, and editing source code, as well as interacting with an IDE by, e.g., accepting or rejecting autocomplete or autosuggestion code or code templates.

Permissions are assigned for various operations, with IDE directive keywords, or assigned by code constructs or context. When an event is triggered, if the operation is associated with a portion of source code having a permission requirement, the permission is checked for the user, and a workflow for the operation is executed. A workflow may include simply executing the operation (when permission requirements are satisfied) or denying execution of the operation when not. Additionally, errors, warnings, messages to other team members, event logging, code synchronization, permission requests, and so forth may all be incorporated in workflows.

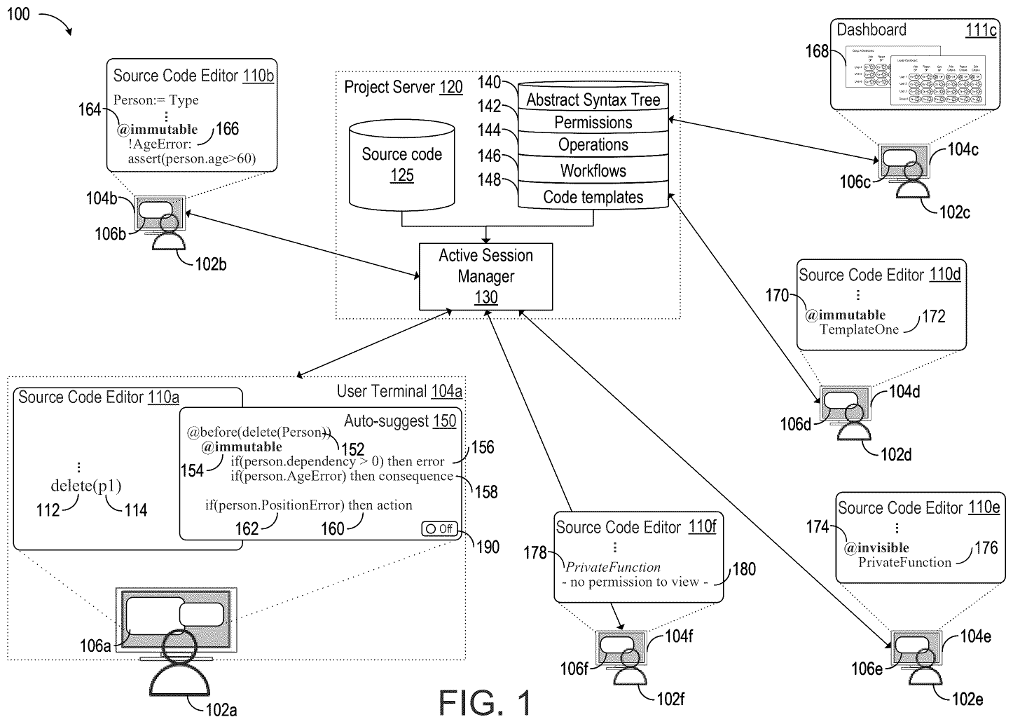

FIG. 1 is a distributed Integrated Development Environment (IDE) 100. Six users 102a-f are equipped with user terminals 104a-f. Each user terminal has a local IDE (106a-f) comprising a source code editor (110a-f). The user terminals 104 are interconnected allowing them to synchronize and share various attributes and source code between them. Each IDE 106 need not be identical. Various aspects will be illustrated below whereby users 102 edit source code within a shared project. In this example the users 106 interconnect via project server 120, which serves and synchronizes project data to and with users 102 via active session manager 130. Project data includes, inter alia, source code 125, abstract syntax tree 140, permissions 142, operations 144, workflows 146, and code templates 148.

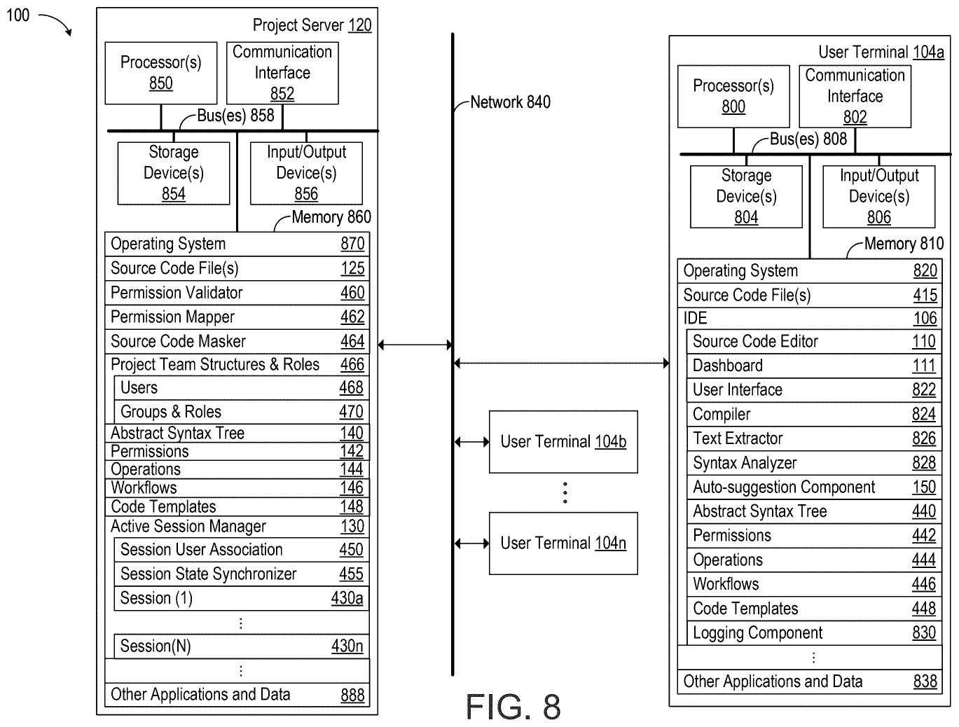

User terminals 104 and project server 120 comprise memories storing various applications, modules, or components connected to processors for application execution, including various components of an IDE, detailed further below with respect to FIG. 8. Here users 102 using source code editors 110 and/or dashboards 111 perform various IDE actions while collaborating on a software development project, examples of which are illustrated in further detail below.

Operations 144 are defined to identify IDE actions that will require permission validation prior to executing. Permissions 142 contain the permission assignments for any selection of users, groups of users, or projects. They can be set at any granularity, from specific operations on a specific construct for specific users, to group level settings for some operations, to project level permissions for classes of constructs, and any other grouping of permissions, operations, and users. Workflows 146 are designed to contain the activities specified when defined operations 144 trigger the workflow and may have various branches of the workflow for one or more permission levels and operative in response to a permission level for an operation being satisfied or unsatisfied. In FIG. 1, user 102c is shown as an example lead developer, which has permissions to access permissions 142 via a dashboard 111c and is able to review and set permissions 168 for users, groups, and operations. In this example the lead developer can design, view, and modify operations 144 and workflows 146 as well (details not shown). Naturally these activities can be restricted or allowed to any number of developers as desired for a particular development project.

User 102b is shown editing source code in editor 110b where a behavioral property (BP) 166 is being entered into a definition for type Person. BP 166 !AgeError is defined to return a positive Boolean value when the numerical property age of an object of type person is greater than 60. User 102b is modifying BP 166 with an IDE directive keyword 164, @immutable. The @immutable IDE directive keyword 164 is used to identify a portion of source code that requires a certain permission level for performing operations related to that portion of code. In this example, permission is required for a user to enter an @immutable BP into a type definition. Other permissions may be required in order to edit or view an @immmutable BP. Here user 102b has the required permission and so the source code entry is allowed.

Code templates 148 are designed and stored for use with auto-suggestion features of the IDE. User 102d is shown editing a code template, TemplateOne 172, and is marking that template with the @immutable IDE keyword 172. As with behavioral properties, in this example, permission may be required to edit code templates, and additional permission may be required to mark a template @immutable. When a portion of the a code template 148 is marked @immutable, then, like with the source code example in editor 110b, a user encountering, for example, an auto-suggestion feature incorporating that @immutable code template may require certain permissions to perform various operations related to the code template, such as rejecting an auto-suggestion, editing the relevant auto-suggested code, or viewing the details of code within or related to that marked code. Here user 102d has the requisite permission and is able to edit and store the code template 172.

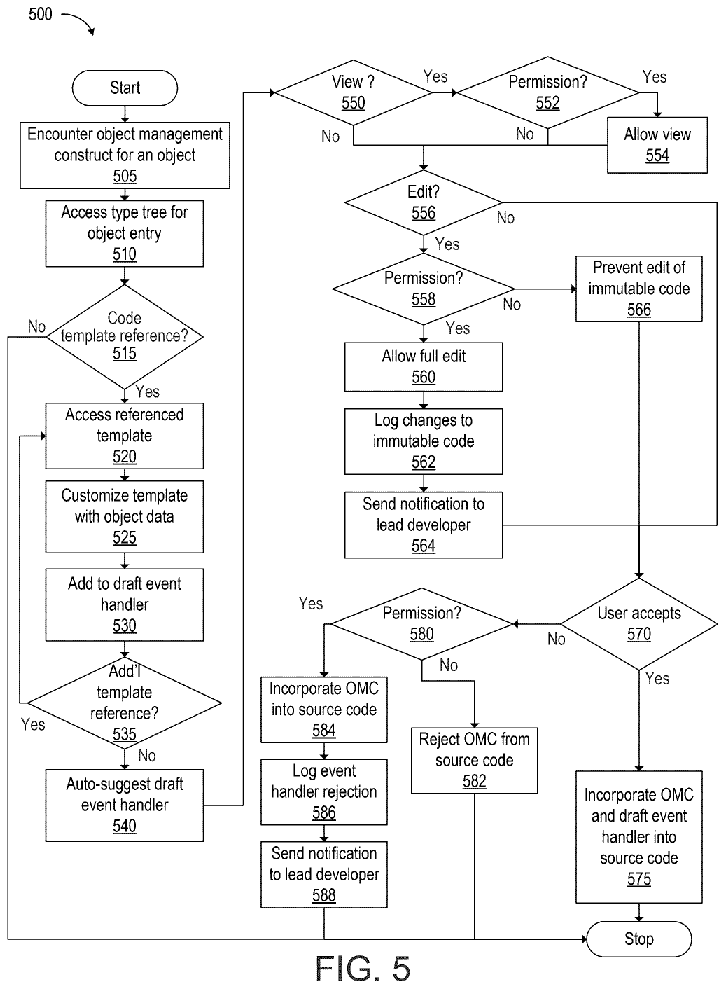

User 102a is entering code in source code editor 110a which triggers auto-suggest function 150 which presents a code template 152, customized according to the triggering code. User 102a will need to have requisite permissions to perform operations such as rejecting, editing, or viewing related code within the auto-suggest feature that are associated with marked code, such as with an @immutable IDE directive. An illustrative example is detailed further with respect to FIG. 5 below.

User 102e illustrates the use of another IDE directive keyword, @invisible 174, which is being added to mark an illustrative source code construct labeled PrivateFunction 176. User 102e may require permission to perform the operation of adding @invisible to source code. Users require permission to view source code marked @invisible, while those users without that permission can still incorporate and compile @invisible functions. The distributed IDE can deploy any of a variety of techniques to provide permission-based viewing of or exclusion from source code while still providing access to the compiler, examples of which are detailed below.

User 102f illustrates one example of @invisible applied to source code. Here PrivateFunction 178 is entered in editor 110f. Imagine an IDE source code editor which provides the ability to view underlying functions, variables, or procedures in response to a user activity via a user interface such as selecting or mousing over that code. Or perhaps the user loads source code containing the PrivateFunction 176 definition introduced above. When that code is marked @invisible, any of those viewing operations will be prevented unless the user has the requisite permission. In this example, PrivateFunction 178 is shown italicized to indicate the contents of PrivateFunction are invisible, and any attempt to load those details are met with an indication 180, such as “—no permission to view—”, as shown. Indications like italics, greying out or changing text color, and types of messages or any message at all are all optional. The key aspect of @invisible is that source code viewing is restricted except for users with permission while all users can utilize and compile it.

Note that @immutable is a directive to the IDE. As such, it is not a keyword in the underlying programming language, or other keyword used for compiler directives. Examples of compiler directives are detailed in detailed in copending U.S. patent application Ser. No. 18/423,784, entitled “Construct-Modification Tags For Development-Phase Compiler Requests,” filed 26 Jan. 2024, by Sridhar Vembu et al., which is incorporated herein by reference (hereinafter the '784 application).

A reference to a particular keyword in the methods, systems and devices described herein applies equally to any transformation or alternate representation. The embodiments described herein use IDE directive keywords @immutable and @invisible chosen to illustrate various aspects of those respective keywords. Those of skill in the art will readily substitute alternate keywords (which may or may not also be illustrative in any language) which simply should be differentiable from keywords of the programming language or languages being employed or other keywords such as compiler directives.

In the example embodiment IDE directive keywords are included in source code for use within the IDE but are not compiled into executable instructions. They may be removed before compilation. Alternatively, a compiler may be designed to ignore IDE directive keywords. An IDE or compiler may alert developers to remove an IDE directive keyword prior to entering the production phase of a software development project (as detailed in the aforementioned '784 application).

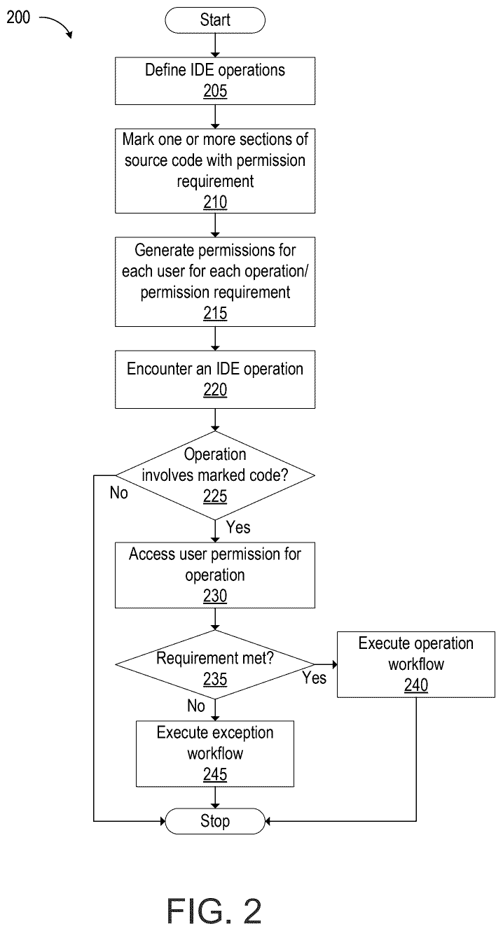

FIG. 2 is a flowchart 200 illustrating a method of workflow, operation, and permissions management in a distributed IDE. A set of IDE operations is defined for a group of users collaborating within the IDE environment, on a project, for example, or within a company, for another (205). As users work on the source code, or when a lead developer creates code templates, or in any other fashion, one or more sections of source code are marked with one or more permission requirements (210).

Alternatively, operations on a particular construct or construct class may be defined to require permissions. For example, a group of constructs with intrinsic characteristics may belong to a class identified with those characteristics, and operations may be defined requiring permissions for those constructs. For example, Link-type objects, detailed further below, comprise a Dependent Data Type (DDT) and an Independent Data Type (IDT). An operation requiring permission may be defined for all DDTs, or all IDTs, as an illustration. Other operations within the IDE may also have permission requirements defined for them, including defining operations, setting permissions, requesting permissions, etc.

Permissions are generated for users and/or groups and subsets of users for operations associated with the permission requirements (215). As illustrated above, separate permissions for operations like viewing, adding, and editing code marked @immutable can be generated for each user and/or group of users.

An IDE operation is encountered (220). This can include an attempt to add defined code types, edit source code, hovering over a particular part of source code or auto-suggest code with a mouse or trackpad, respond to an IDE prompt with a mouse click or hotkey, loading source code, viewing all or part of source code, adding IDE directives, and various other IDE operations well known to those of skill in the art. If the IDE operation is determined not to involve any marked code (225), the process stops.

If the IDE operation does involve marked code (225), then the permission associated with that operation and marked code or marked code type is accessed (230). If the permission requirement is met (235), then an operation workflow is accessed and executed (240). If not, then an exception workflow is accessed and executed (245). Then the process stops.

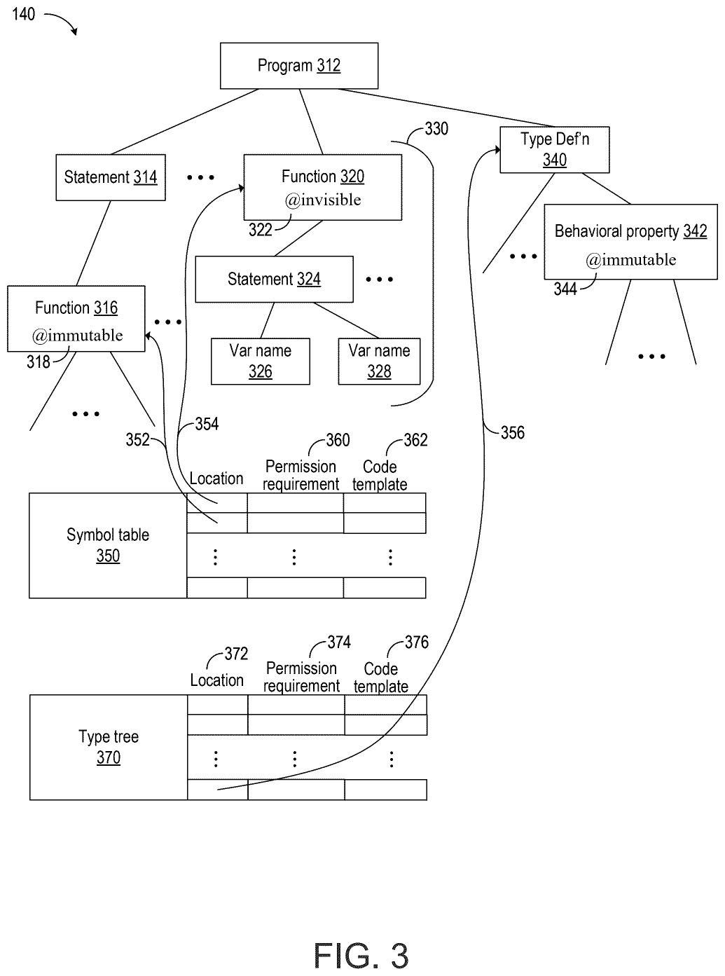

FIG. 3 conceptually illustrates an embodiment of an Abstract Syntax Tree (AST) 140 configured for marking source code for permission requirements. Here a graphical illustration of an AST (commonly implemented in text format) is interconnected with a Symbol Table (ST) 350 and a Type Table or tree (TT) 370. A parser is a component typically part of a compiler that processes source code and generates the abstract syntax tree, symbol table, and type table.

The AST is a tree representation of the abstract syntactic structure of the source code. Each node in the tree corresponds to a construct in the language, such as expressions, statements, function declarations, etc. The AST abstracts away certain syntactic details (like parentheses) that are not essential structure of the code for subsequent processing steps such as semantic analysis, optimization, and code generation. Any data can be stored in a node that is useful for these tasks, and additional information useful to the exemplary IDE may be stored in these nodes as well, such as IDE directive keywords, permission information, associated operation information, and code template information useful for autosuggestion. In FIG. 3, program 312 of AST 140 has root level branches connecting to a statement 314, a function 320, and a type definition 340.

A symbol table is a data structure used by a compiler or interpreter to store information about the identifiers (names) used in a program. For each identifier, the symbol table records information such as its type (e.g., integer, float, function), scope (the context in which the identifier is valid), and possibly its location in memory. The symbol table is useful for semantic analysis phases of compilation, such as type checking and scope resolution, ensuring that identifiers are used consistently and according to the rules of the programming language. In this example, symbol table 350 comprises location 352 pointing to function 316 and location 354 pointing to function 320. In addition to other data used for compiling or interpreting, symbol table 350 can have a permission requirement 360 stored for any symbol name. While a permission can be stored in an AST node, a symbol table can provide a convenient alternate for quick retrieval of a permission for an encountered symbol in the IDE. Optional code templates 362 may be stored in a symbol table 350 associated with a symbol as well. Embodiments may be designed such that permissions and code templates can be applied to individual symbol table entries, as well as programmatically applied to groups of constructs, such as certain functions or procedures, as well as types (a type table or tree, detailed below, can be useful for this as well).

Function 316, a node nested within the branches of statement 314, has been marked @immutable 318. In this example, a permission requirement 360 associated with the function 316 will indicate which operations involving function 316 require a permission level in order to perform the operation. For example, this function may be defined to be immutable by any user below a threshold permission but allow any user to view the function. An example where this is useful is in cases where junior developers benefit from understanding the details of a critical component of the software development but should not be allowed to make changes to those core components.

Location 354 points to function 320, which has been marked with IDE directive keyword @invisible 322. The AST can define the scope 330 of function 320, which includes statement 324, variable name 326, and variable name 328. Thus, the respective permission requirement 360 will prevent viewing of the function 320, as well as any code within scope 330, by any user without the required permission. One illustrative use case for such a feature is the ability to make available proprietary intellectual property for compiling but not viewing, for example, to users outside of a company. In this case, the proprietary code sharing is limited to IDE environments that will comply with the permission requirements.

A type table or tree is a data structure that contains information about the types defined in the program, including built-in types (like int or string) and user-defined types. For each type, the type table stores information about its structure (e.g., the fields of a user-defined type or the parameters of a function), its size, and how to operate on instances of the type (e.g., which operations are supported and how they are implemented). The type table is useful for type checking, ensuring that operations in the program are performed on compatible types, and for generating the correct code to manipulate data according to its type. Type tree 370 may include locations 372 for each type, such as a pointer 356 to type definition 340. A type tree may include all object definitions with references to the respective type definitions. Or the symbol table may include a link or reference for an object to a type in a type table or tree. In the example embodiment, a type tree can be used in similar fashion as detailed above with a symbol table but allows for permission requirements 374 as well as code templates 376 to be identified for classes of objects. These classes can be user defined or may be based on inherent characteristics of the types.

Within the scope of type definition 340 is a behavioral property 342, which is marked @immutable 344 in this example. It can be used to affect operations associated with the behavioral property 342 itself, as well as those associated with the type 340, an example of which is an event handler for managing objects of the type 340, illustrated further below.

In the example embodiment, the programming language provides for link types. Link types are defined wherein an Independent Data Type (IDT) is referenced in defining a Dependent-link Data Type (DDT). Examples of link types and dependencies, referred to therein as role sharing types and dependencies, are detailed in U.S. patent application Ser. No. 18/335,035 to Sridhar Vembu et al., filed 14 Jun. 2023, and entitled “Role Extensions For Programming Languages,” which is incorporated herein by reference. Role sharing objects in the '035 application are referred to as linked objects herein. Linked objects may alternately be referred to as link or link-type objects. The types defined to instantiate linked objects are referred to as linked types.

Link types illustrate examples of inherent class. A link type can be an IDT, a DDT, or both. Due to the inherent relationship of linked objects, checks are performed at runtime prior to executing a link-type object management instruction on them. A variety of these checks may be defined for different types and constructs, which are referred to generally as link type criteria. When defined link type criteria are satisfied for a link-type object management instruction for an object at runtime, the instruction is carried out. For example, deletion of an IDT object may be prevented when there are DDT objects dependent on it. Instructions to check dependencies of an IDT object before deletion are applicable across the entire class of IDT types, and so a code template incorporating those instructions can be stored in code templates 140, accessed with a code template reference 376.

The following code snippet introduces example IDT and DDT type definitions:
1 Person:=Type #IDT
2 Name:=String
3 Aadhaar:=Number (unique) #ID Structural Property
4 Age:=Number
6 Employee:=Person #DDT
7 Designation:=String

Lines 1-4 define Person as a Type. This is an example of an Independent Data Type (IDT) defined with the built-in construct Type. Person has property Name, which is a string, property Aadhaar, which is a number and is defined as a unique property. An Aadhaar is an identification number for people in India. A social security number (SSN) is a similar identifier in the United States. A Person also has numerical property, Age, in this example. In the source code, “:=” denotes a type or element declaration and “:” denotes element or object usage. The use of pascal case (PascalCase) for object and element identifiers indicates a declaration and the use of snake case (snake_case) represents object and element usage. The delimiter “#” identifies comments.

Lines 6-7 define Employee as type Person. Employee is an example of a Dependent-link Data Type (DDT) as it is derived from IDT Person. Employee and Person are link types, as a person object can be instantiated, and an employee object can be linked to that person object. In this example, an employee has property Designation, a string which identifies an attribute for the employee.

The creation or existence of a DDT type instance is dependent on the creation or existence of the corresponding IDT type instance, and the DDT instance or object is linked to the IDT object or instance automatically. IDT Person and DDT Employee are used for illustration. While linked types are quite useful for all sorts of human related roles and activities, they are by no means limited as such. An IDT tool may have a DDT wrench. An IDT vehicle may have a variety of DDT object types, such as a motorbike, automobile, or truck. A hospital may be a DDT of an IDT building. The number of various possible combinations of link types is quite unlimited. Link types are exemplified by the creation and existence of a DDT type object depending on the creation and existence of the corresponding IDT type object, with the DDT object being inherently linked to the IDT object. However, an IDT object can be persistent in memory even after a corresponding DDT is deleted (unless and until the IDT object is deliberately deleted).

Inherent class membership is determined according to the aspects of the programming language being used, and optionally in conjunction with a compiling function. In the example embodiment a type may be in the inherent class of IDT, DDT, or both. This is determined from a parse tree showing dependencies between link types. Each type may also be a member of one or more user-defined classes. A variety of techniques can be deployed to determine membership in a user-defined class. For example, a configuration file for a project may be maintained comprising user-defined classes and their type members. Class membership may or may not automatically include dependent types. If a type is determined to be a member of an inherent class for which source code templates are available, then a reference to each applicable code template is inserted in the type tree 130 for the type. Similarly, if a type is determined to be a member of a user-defined class for which code templates are available, then a reference to each applicable code template is inserted in the type tree 130 for the type.

Event handler autosuggestion in accordance with an AST 140 and alternate data structures with support for inherent and user defined type classifications, including IDTs and DDTs, is illustrated in copending U.S. provisional patent application Ser. No. 63/631,835, entitled “INTEGRATED DEVELOPMENT ENVIRONMENT OBJECT MANAGEMENT CODE AUTO-SUGGESTION,” filed 9 Apr. 2024, by Sridhar Vembu et al., which is incorporated herein by reference (hereinafter the '835 application).

The AST 140 represents the structure of the code, the symbol table 350 provides a mapping of identifiers to their attributes, and the type table 370 describes the properties of types used in the program. The AST 140 is used for structural and syntactic analysis, transformations, and code generation. The symbol table 350 is used for semantic analysis, including scope and type checking. The type table 370 is specifically used for managing type information, ensuring type safety, and guiding code generation for type-specific operations. The AST 140 contains nodes representing syntactic constructs. The symbol table 350 contains entries for identifiers (variables, functions, etc.) and their attributes. The type table 370 contains entries for types and their characteristics. Together, these components enable a compiler or interpreter to evaluate the program, check it for errors, optimize it, and ultimately translate it into a target language or machine code, ensuring that the resulting code behaves as intended by the source code.

When augmented with IDE directive keywords, defined operations and permissions, and workflows, the compiling or interpretive usefulness of these data structures can be expanded to provide for enforcing disciplined coding principles, permission-based workflows, logging, and communication between a development team.

An IDE in the example embodiment may have its own parser or may employ its built-in compiler to parse source code into a data structure useful for marking source code with permission requirements such that operations acting on marked code can trigger a permission check as well as access an appropriate workflow.

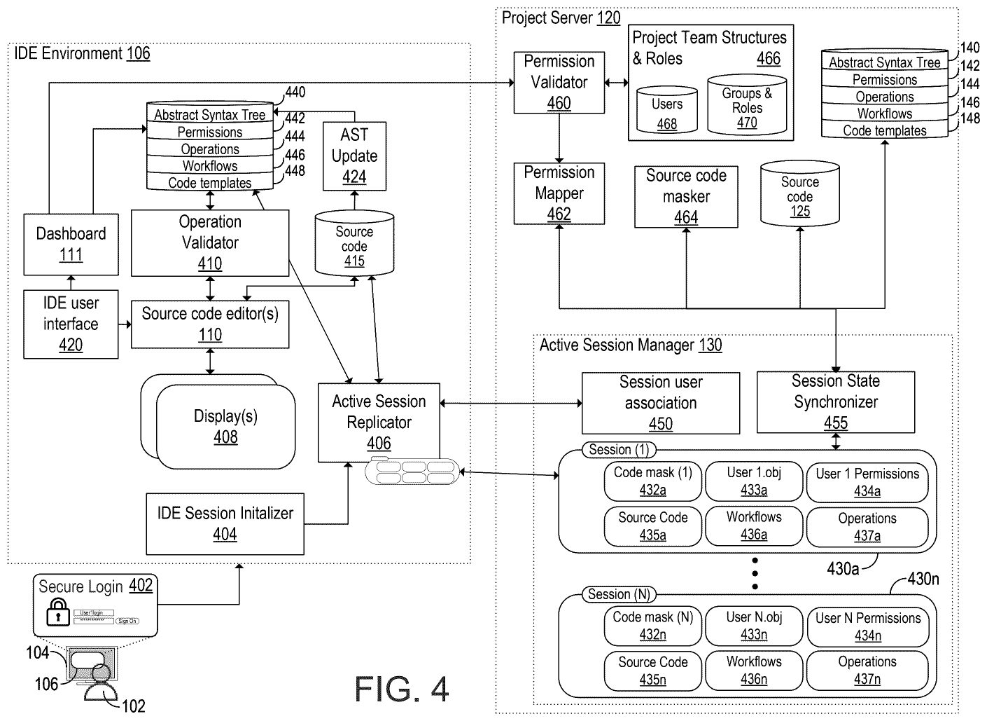

FIG. 4 illustrates a local IDE environment 106 interacting with project server 120 in a distributed IDE environment. User 102 via user terminal 104 enters credentials into secure login 402 to begin an IDE session 106. The IDE session begins with IDE session initializer 404, which triggers active session replicator 406 to interface with the active session manager 130, a component of project server 120. Active session manager 130 maintains active sessions 430a-430n for each of N users. This allows any logged in user to access the state of their session from any device, and keep that state synchronized between one or more devices. A user can remain logged in to the project server and that user's state will be retained. When a user logs out completely that active session can be removed.

Upon initialization, the session user association module 450 determines whether an active session exists for the user. If so, then the active session 430 data is delivered to the active session replicator 406. If one does not exist then session state synchronizer 455 retrieves project specific data and user specific data to create an active session and delivers it to active session replicator 406. In either case, the data is used to populate the local IDE environment 106. Here, active session 430a for User 1 comprises project level data including source code 435a, workflows 436a, and operations 437a. These are kept synchronized with those of other users via open active sessions, as well as with project server 120. Source code 435a includes source code 125 and can include code templates 148. It can also include a copy of abstract syntax tree 140, although that can also be regenerated by the local compiler in IDE 106. Permissions specific to User 1 are supplied from permissions 142 as User 1 permissions 434a.

Active session manager can use a communication specification such as Publish-Subscribe (Pub/Sub) or REST API. In a Pub/Sub system, messages are published to a topic by a publisher, and any number of subscribers can receive those messages by subscribing to that topic. The system decouples the publisher of a message from its subscribers in time and space, providing a flexible, scalable, and dynamic messaging infrastructure. Messaging is asynchronous, so publishers can continue processing without waiting for subscribers to receive messages, enhancing system efficiency and responsiveness. They can easily scale to accommodate a large number of publishers and subscribers, as well as a high volume of messages. These and other features make Pub/Sub systems ideal for a wide range of applications, from real-time data distribution and microservices architectures to event-driven workflows and message broadcasting, and well suit active session management, including synchronizing state and data, between a project server 120 and various user terminals 104.

A variety of state elements are captured and stored in the User 1.obj file 433a. In the context of session management, a Session Object File, or .obj, may be a serialized object or data structure used by an active session manager to store session data temporarily. Active session managers handle the lifecycle of user sessions in an application, including creation, maintenance, and termination of sessions. The “.obj” file in this scenario could be a file format or naming convention used to store session-specific data on the server side, such as user preferences, authentication tokens, or other temporary state information. This session data maintains the state of an interaction between a client and a server, especially in stateless protocols like HTTP where each request is independent of the last. By managing session data, applications can provide a personalized and cohesive experience to users across multiple requests and interactions.

A code mask (1) 432a is included which, along with source code 435a, allows the IDE to manage the source code visible to the user in accordance with any permission requirements and the user's permission levels. In one embodiment, source code 435a with visibility permission requirements may be encrypted with decryption accessibility only available to the compiler for compiling and to users with the appropriate permission level settings. Source code masking and/or encryption may be executed in source code masker 464 to provide the user level source codes 435 and masks 432 for the various user sessions 430.

Permissions are set by one or more users with permission clearance to do so, such as project managers or technical leads. When a user 102 has such clearance, he or she can access dashboard 111 via IDE user interface 420 and set permissions for users and/or groups. One example is illustrated below, but those of skill in the art will readily apply alternate permission schemes and hierarchies, in accordance with IDE design specifications as well as tailoring to the needs of particular organizations and projects. Dashboard 111 interfaces with project server 120 via permission validator 460, which has access to the project team structures & roles 466, which in this example includes users 468 (e.g. a SQL server) and groups & roles 470 (e.g. an LDAP server). The permissions are stored in permissions 142 and made available to the user permissions 434 in the active sessions 430 via permission mapper 462.

SQL (Structured Query Language) servers are database servers that use SQL as the primary language to manage and manipulate relational databases. SQL is a standard programming language specifically designed for storing, manipulating, and retrieving data in databases. SQL servers are widely used due to their efficient handling of structured data, transactions, and complex queries. Examples of SQL database management systems include Microsoft SQL Server, MySQL, PostgreSQL, and Oracle Database. LDAP (Lightweight Directory Access Protocol) servers are protocol-based servers that manage and access directory information services over an IP network. LDAP is used for storing organizational information and providing directory services, such as email addresses, usernames, and group memberships. It is optimized for reading, searching, and browsing rather than writing or updating data, making it ideal for quick lookup and authentication services. Examples of LDAP implementations include Microsoft Active Directory, OpenLDAP, and Apache Directory Server.

Active session replicator 406 populates the IDE environment 106 state upon session initialization and synchronizes with the project server 120 as appropriate. In this example the local session includes abstract syntax tree 440, permissions 442, operations 444, workflows 446, and code templates 448. The user operates on source code 415 via IDE user interface 420 and one or more source code editors 110 as well as with the local IDE compiler. As edits are made, AST update 424 (optionally using the functions of the local compiler) maintains and updates AST 440 with any permission requirement markings, e.g. via IDE keyword directives. Those made via other users are also updated via synchronization with active session replicator 406 and active session manager 130.

When a user is active developing source code in IDE 106, any number of IDE trigger activities are captured via IDE user interface 420 within one or more source code editor windows managed by source code editors 110. These are typically visible in one or more windows on one or more displays 408.

IDE-captured trigger activities are managed with operation validator 410, which has access to the project specific operations 444, workflows 446, and code templates 448. The permission requirements for various operations are available in AST 440 (or any other set of data structures, as described above). For each operation, if a permission is required, the appropriate permission is checked, and the appropriate workflow is retrieved and carried out.

In one example, an IDE trigger occurs when a user types a particular construct that invokes an event-handler autosuggestion display, in this case the construct is an object management function. A programming language provides for user defined types, which, when compiled, produce instructions for the use of objects of the defined type. Types are defined for use in instantiating objects at runtime. Objects can be affected by object management instructions compiled from object management constructs. Examples include create, update, and delete. Create, update, and delete functionality is built into the example compiler and accessible to developers using the example programming language.

Event handlers are used in programming to perform a set of actions in response to a defined event occurring and can be used in conjunction with object management functions. An event handler may be called prior to performing or subject to completion of an object management function (OMF). An event handler may include instructions that are applicable to a specific object type or instructions that are useful to a group or class of objects. A class of objects may be identified by properties that are inherent in the programming language or may be user defined. Code templates 448 for all of these sets of instructions can be defined, stored, retrieved, and customized for insertion into an event handler for an object management function operating on an object type, as defined by one or more workflows 446.

An IDE is deployed to assist developers using object management functions in programming source code. When a developer, through a user interface to the IDE, enters an object management function operating on an object type in a source code editor, the IDE auto-suggests a draft event handler for that object management function as applied to that object type. The draft event handler will be populated with any source code templates that are applicable to the inherent class of the object type, any source code templates that have been user-defined for a group including the object type, and any source code templates that have been user-defined for the specific object type, each customized appropriately for the object type.

FIG. 5 is a flowchart 500 illustrating an example workflow for generation of a draft event handler for auto-suggestion and permission-based editing and incorporating the draft into source code. The flowchart is described using the example of user 102a editing source code introduced with respect to FIG. 1, and illustrates components detailed in FIG. 4 as well.

Turning to FIG. 1, user 102a enters an object management construct operating on an object of a defined type into source code editor 110a. An event handler associated with the object management construct is presented to the user for review, editing, and acceptance into the source code which user 102a is generating. Here a delete construct 112 operating on p1 114, which is an object defined by type Person, is entered into the source code editor 110a. IDE 106a has a data structure comprising the syntax structure and semantic model of all or part of the source code parsed while user 102a is editing, and continually updates the syntax structure and semantic model based on the editing input. In this example abstract syntax tree 440 is used as the data structure, where at least the type names and variables of those types from the data structure are parsed into a type tree 370. A text extractor component of the IDE extracts keywords which are operated on by a syntax analyzer which, among potentially other analysis functions (shown below in FIG. 8), determines when an object management function has been entered. When new types or type variables are defined, the type tree 370 is updated with those types or variables. User-defined behavioral properties and IDE directive keywords are also extracted, analyzed, and used to update the type tree 370 and/or generate source code templates. Additional details pertaining to BP extraction, template generation, and auto-suggesting event handlers are found in the aforementioned '835 application.

Code templates 448 contain templates for use in creating a draft event handler. Source code templates are referenced in various entries in type tree 370. In this example, source code templates for type Person are assembled into a draft event handler 152 and customized with the type Person. The draft event handler 152, for the delete function in this example, is identified by the @before keyword, operating on delete (Person). Using auto-suggestion component 150, the draft event handler 152 is presented to user 102a. In the example embodiment a pop-up window allowing the user to accept, reject, or potentially edit the draft event handler 152 appears in a display 408. Various alternative methods to allow a user to view and edit an auto-suggested piece of code may be deployed. If the draft event handler 152 is accepted by the user, as edited if applicable, it will be incorporated into the source code under development in IDE 106a (and potentially source code of other developers synchronized within IDE 100).

Turning again to FIG. 5, the process begins with an object management function for an object being encountered (505). Here user 102a is entering a delete 112 operating on a type variable p1 114. Text extractor and syntax analyzer components may be used to determine whether object management functions are encountered. Then type tree 370 is accessed (510) to locate the type variable matching p1 114. In type tree 370, a matching type variable named p1 is associated with type Person. If the record in the type tree for the associated type contains one or more code template references (515), then the referenced template is accessed (520) from code templates 448. If not, the process stops. In this example, the first reference in the record for type Person indicates that Person is part of the inherent class IDT. Since the object management function encountered is a delete function, the template matching that context is retrieved (520). The template is customized as appropriate with the type name (525) and added to a draft event handler (530) accounting for the immutable marking of the template.

At this point in the example, draft event handler 152 comprises the event handler construct customized for type Person in a delete context, @before (delete (Person)), as well as the operation 156 derived from a template 448: if (person.dependency>0) then error. This pseudocode example illustrates one link-criteria aspect: a delete of an IDT should be executed when there are no dependencies to avoid an orphan DDT. Thus, based on this instruction, at runtime, an error will be generated, and the event handler will abort the deletion of the Person object if a dependency exists. The location of operation 156 in the event handler follows the @immutable keyword 154 in accordance with the immutable marking on the template. A variety of user-interface design techniques may be employed. In an alternate embodiment, immutable code may be a different color than mutable code. The immutable keyword may be omitted when another mutability marker is employed.

Other link-type template operation examples include checking for the existence of an IDT object prior to creating one in response to an IDT create object management function, and only creating the object when it is not found. A check for existence of an associated DDT object may be made in response to a create IDT object management function, with the consequence that the IDT object is created if not found. Thus, generating an error in an event handler is just one of the many options available. Any number of operations may be incorporated in an event handler, and therefore those operations may be designed into corresponding event handler templates as well.

Event handlers for link type object management comprising additional example link-type criteria instructions and other techniques to regulate link type object management at runtime are detailed further in several copending patent applications.

A compile-time link type manager may ensure that all link type object management constructs have associated event handlers at compile time, and that such an event handler meets certain criteria for the particular link type. An example compile-time link type manager enforcing source-code defined event handlers is detailed in copending U.S. patent application Ser. No. 18/405,699, entitled “Compile-time Link Type Object Management,” filed on 5 Jan. 2024, by Sridhar Vembu et al., which is incorporated herein by reference (hereinafter the '699 application).

Embodiments detailed in the '699 application can be combined with other object management techniques. For example, built-in object management functions are extensible to include link-type criteria in the type definition in source code. Extensible built-in object management functions are detailed in copending U.S. patent application Ser. No. 18/406,003 entitled “Extensible Built-In Object Management,” filed on 5 Jan. 2024, by Sridhar Vembu et al., which is incorporated herein by reference (hereinafter the '003 application).

In an alternate embodiment, an event handler in source code is not required, as a general-purpose runtime object management engine is provided for affecting link-type objects at runtime that may include one or more of the desired link-type criteria built in. Example embodiments are detailed in copending U.S. patent application Ser. No. 18/405,916, entitled “Runtime Support for Link Type Object Management,” filed on 5 Jan. 2024, by Sridhar Vembu et al., which is incorporated herein by reference (hereinafter the '916 application).

Example link-type criteria includes determining the existence of an IDT object, determining whether a dependency such as a DDT object exists, and evaluation of constraints specific to an object management function (e.g., create, update, or delete) or specific to a link object type (e.g., IDT or DDT). Link-type criteria can be evaluated in different phases. For example, an event handler, as just described, may be used to evaluate criteria prior to an object management function execution, like determining whether an IDT object exists prior to creating an object dependent on that object. Other link-type criteria may be evaluated during an object management function, using object management extensions as detailed in the '003 application.

Returning to FIG. 5, if there are additional references associated with the encountered type (535), the process loops back to access the appropriate template (520). Here, there is second reference for Person: behavioral property !PositionError referring to a corresponding template in code templates 448. In this example !PositionError has not been marked @immutable. The customized template (525) is added to the draft event handler (530). Referring again to FIG. 1, as the BP was not marked @immutable, the customized template has not been marked @immutable, it is placed outside the source code area delineated by the immutable marker. Here, at runtime, the customized operation 160 accesses the Boolean result of behavioral property person. Position Error 162 and performs an action when the result is true.

The process continues (535) to retrieve a third template for behavioral property !AgeError. The customized template (525) is added to the draft event handler (530) in accordance with its having been marked immutable with the @immutable keyword entered by user 102b. Customized operation 158, at runtime, performs a consequence when person.AgeError results in a true value. Having exhausted the possible template references (535), the auto-suggestion component displays the draft event handler to the user for review (540).

In the example embodiment, the auto-suggestion component presents the draft event handler in an editable source code window, as shown in FIG. 1. The user may make any edits to the mutable portion of the event-handler draft code by default. This may include changing an action defined in response to a user-defined behavioral property, or defining one if the template did not already include one. In one embodiment, a user may select or mouse-over a behavioral property or other function within the auto-suggest window and the relevant definitional code will be displayed, unless that code has been marked @invisible.

In one example embodiment, a toggle switch 190 (reading Off) is deployed in the lower right corner of the auto-suggest 150 window. This is a type of safety feature. When this is set to Off, then the user is unable to edit any code marked immutable. This toggle may be turned On to allow editing of the entire code, which may require the user to have certain permissions to do so. When a user overrides an immutable marking on one or more pieces of the draft event handler, those changes are logged in a log file for the project and messages to other developers may be generated. In an alternate embodiment, no toggle is deployed, and a developer may simply edit as allowed by that user's permissions. In the example embodiment, enabling the toggle 190 will bring up the user's permission dashboard 111, where a selection of permission settings are available to potentially alter.

Once the user has been presented with the draft and optionally made any desired edits, the user may accept or reject the draft (in accordance with permission to do so). If accepted, the draft event handler is incorporated into the source code. If rejected, the event handler will not be incorporated in the source code. In the example embodiment, rejecting a draft event handler having one or more immutable portions will prevent the use of the object management function in source code, unless otherwise overridden.

These aspects are illustrated in flowchart 500. If the user performs an IDE action that would trigger an operation requiring a view of a portion of the event handler draft or one or more portions of definitional code underlying one of its constructs (550), then permission to view is checked (552). If the event handler draft or definitional code are not marked as requiring permission, whether by @invisible marking, or otherwise limited by an IDE setting, then naturally all users will be able to view. If permission is required, the user's permission levels are checked. If the user has the required permission, then viewing of the code is allowed (554), otherwise viewing is not allowed. In all cases proceed to check whether the user attempts to edit (556).

If the user attempts to edit then permission to do so will be evaluated (558). Without the appropriate permission, if an attempt to edit a portion of the event handler draft that is marked @immutable is made, then the edit will be prevented (556). If the user has permission, then full edit is allowed (560). In this embodiment, when @immutable code is edited, those changes will be logged in a project log (562). In addition, a notification will be sent to a lead developer (564).

After any viewing or editing is complete, the user responds to a prompt to accept the draft event handler into source code (570). If the user accepts (575) then the object management function (delete (p1) in this illustration) and the auto-suggested draft event handler (as optionally edited) are incorporated into the source code, and the process stops.

If the user wishes to reject the auto-suggested event handler, and any portion of the event handler has a mandatory component, such as code marked @immutable, then permission to do so is verified (580). If the user does not have the requisite permission (582) then event handler is discarded, but the object management function is rejected and not incorporated into the source code. A variety of indications, e.g. notices or error messages, may be generated to indicate to the user why this occurred. Alternately, the IDE could incorporate the event handler into the source code regardless, and only remove it in response to the user removing the corresponding object management function (the delete in this instance). Then the process stops.

If the user does have permission to reject the event handler, then the object management function is incorporated into the event handler (584) without the suggested event handler. The rejection will be logged (586), and a notification will be sent to a lead developer (588) and the process stops.

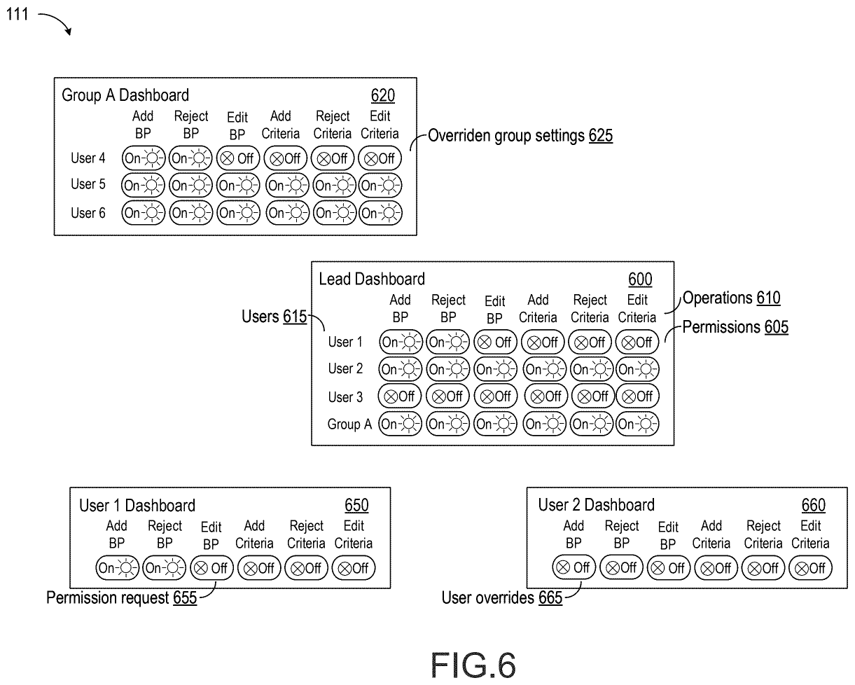

FIG. 6 is an illustration of an example dashboard 111 for managing user permissions. Assume for this example that a user with permission to manage permissions, the lead, has an active IDE session 106 with dashboard 111 open. Here the user sees lead dashboard 600, which comprises a list of users and groups of users 615, operations 610, and permissions 605. In this example, the lead developer sees User 1, User 2, User 3, and Group A. The example operations 610 include Add BP, Reject BP, Edit BP, Add Criteria, Reject Criteria, and Edit Criteria. Other operations detailed herein such as viewing permissions are omitted for brevity. In this window the lead can individually enable each permission for each of Users 1, 2, and 3, by toggling the switches between on and off. Additionally, the lead can toggle a permission setting for Group A, which will then propagate to all users in Group A.

In this example the lead has set all the permissions on for each operation for Group A. The lead can select Group A, if desired, and Group A dashboard 620 will be displayed. Here the lead can use a more granular approach to permissions by overriding the group settings for one or more operations for one or more users. Group A comprises User 4, User 5, and User 6. In this example, the lead overrides the “all on” group settings for User 4, by setting the Edit BP, Add Criteria, Reject Criteria, and Edit Criteria to the off position, as labeled by overridden group settings 625. A lead user may also view an individual user's dashboard if desired. A user can edit settings for itself, being more restrictive but not less restrictive than the settings selected by the lead. In FIG. 6, the lead can view User 1 dashboard 650 or User 2 dashboard 660, each of which have permission settings for the same set of set of operations shown in lead dashboard 600.

Dashboard 111 for a lead user is populated with user and group information retrieved from project server 120 (and users and groups & roles databases 468 and 470 via permission validator 460). As changes are made, those propagate back to update permissions 142. Active sessions permissions 434 will also be updated as necessary, for users affected by the changes either individually or part of a group.

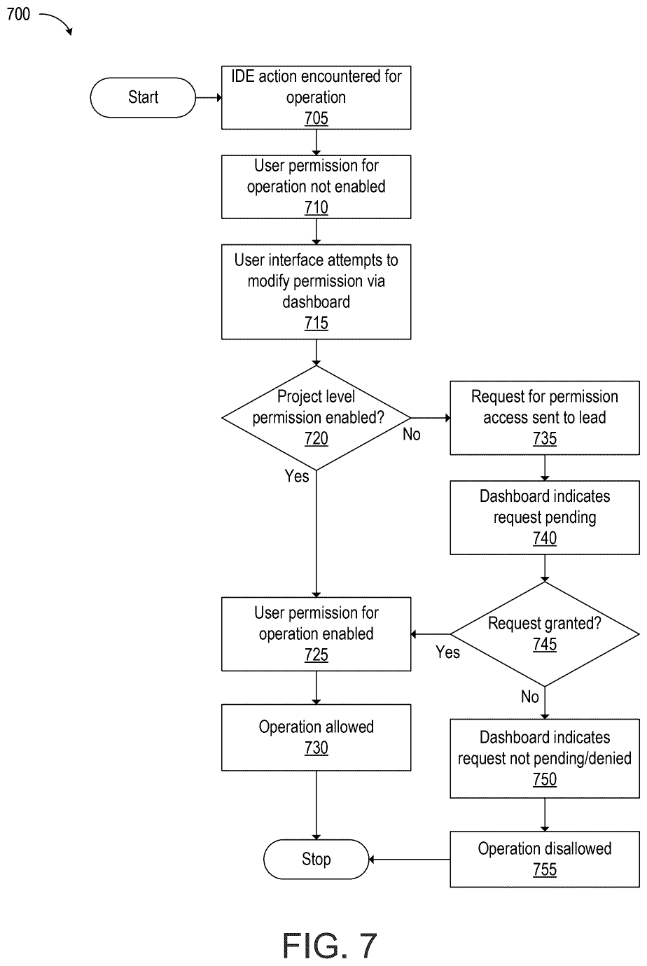

To continue the example illustration, assume now that User 2 has logged into a session in IDE 106 and enabled dashboard 111. Assume User 2 does not have permissions for project level permission editing, so only the User 2 dashboard 660 is visible. In this case, the lead has set User 2's permissions to all on, as shown in lead dashboard 600. However, User 2 has elected to override those permissions by turning them all off, indicated by user overrides 665. This will prevent User 2 from accidentally carrying out any of the operations. However, as illustrated below with respect to FIG. 7, User 2 can at any time return to the dashboard and enable any of the permissions, as the project level permissions are enabled for User 2.

Now consider User 1 has logged into a session in IDE 106 and enabled dashboard 111. Again, assume that User 1 does not have lead level permission editing permissions, so only User 1 dashboard 650 is visible. Here, the permissions for User 1 match those of the project level permissions of lead dashboard 600. However, User 1 wishes to edit a behavioral property, so he or she attempts to enable the Edit BP permission, identified by permission request 655. In this case, a permission request is generated, and an indication, e.g. a message or other indicator, will be sent to a user with permission to grant or deny the request. While the request is pending, the permission may be grayed out or otherwise marked to indicate the response has not yet been received. If the request is granted, then the Edit BP permission will be enabled. If not, then the pending indication will be removed, and the permission will remain disabled.

FIG. 7 is a flowchart 700 illustrating modifying a user permission for an IDE operation. An IDE action is encountered that would trigger the operation (705), and it is determined that the user permission required for that operation is not enabled (710). In one embodiment, when an IDE operation is attempted and the permission level required is not met, the IDE may present an indication with this information and an opportunity to manage permissions. The user, via the user interface, opens the permission dashboard and attempts to modify the permission level (715). If the permission for the user and the operation is enabled at the project level (720) then the user permission for the operation is enabled (725) per the user's request, as the user has the required authority to make the permission modification. Then the operation is allowed (730). In the example embodiment the operation proceeds automatically following the indication presentation and the dashboard access. In an alternate embodiment the user may be required to reinitiate the original operation. Then the process stops.

If the project level permission for the user and operation was not enabled following the user interface attempt to enable the user level permission (720) then a request for permission (735) is sent to a lead developer (or alternate individual, or system, indicated for the IDE to make such requests). The dashboard indicates in some fashion, examples of which just described, that the request is pending (740). If the request is granted (745), then the user permission for the operation is enabled (725) and the operation is allowed (730). If the request is denied (745) the dashboard indicates that the request is no longer pending, and a corresponding indication is displayed (750). The operation is disallowed (755) and the process terminates.

FIG. 8 illustrates an example embodiment of distributed IDE 100 including components of a user terminal 104 and a project server 120. Here user terminal 104a is connected via network 840 with other user terminals 104b-n and a project server 120. However, it should be noted that IDE operating environment and the aspects disclosed herein are not constrained to any particular configuration of devices.

User terminals 104a-n may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, an Internet-of-Things (IoT) device, a distributed computing system, multiprocessor systems, or combination thereof. A user terminal may be configured utilizing a cloud service. The operating environment of IDE 100 may be configured in a network environment, a distributed environment, a multi-processor environment, or a stand-alone computing device having access to remote or local storage devices.

User terminals 104 may include one or more processors 800, a communication interface 802, one or more storage devices 804, one or more input/output devices 806, and a memory 810. A processor 800 may be any commercially available or customized processor and may include multi-processor architectures. The communication interface 802 facilitates wired or wireless communications between the computing devices such as user terminals 104, project server 120, and other devices. The components of a user terminal 104 are communicatively coupled via one or more buses 808.

A storage device 804 may be a computer-readable medium that does not contain propagating signals, such as modulated data signals transmitted through a carrier wave. Examples of a storage device 804 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 804 in the computing devices 104. The input/output devices 806 may include a keyboard, mouse, pen, voice input device, touch input device, display, speakers, printers, etc., and any combination thereof.

A memory 810 may be any non-transitory computer-readable storage media that may store executable procedures, applications, and data. Various of these components and data are detailed above with respect to FIG. 1 and FIG. 4. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc., A memory 810 may also include one or more external storage devices or remotely located storage devices.

The memory 810 may contain instructions, components, and data. A component is a software program that performs a specific function and is otherwise known as a module, program, and/or application. The memory 810 may include an operating system 820, one or more source code files 415, an IDE 106 and other applications and data 838. IDE 106 may include a source code editor 110, a dashboard 111, a user interface 822, a compiler 824, a text extractor 826, a syntax analyzer 828, an auto-suggestion component 150, an abstract syntax tree 440, permissions 442, operations 444, workflows 446, code templates 448, and a logging component 830.

User terminal 104 may utilize an integrated development environment (IDE) 106 that allows a user (e.g., developer, programmer, designer, coder, etc.) to design, code, compile, test, run, edit, debug, or build a program, set of programs, web sites, web applications, and web services in a computer system. Software programs can include source code files 415, created in one or more source code languages (e.g., Visual Basic, Visual J #, C++. C#, J #, Java Script, APL, COBOL, Pascal, Eiffel, Haskell, ML, Oberon, Perl, Python, Scheme, Smalltalk and the like, as well as proprietary or custom-designed programming languages). The IDE 106 may provide a native code development environment or may provide a managed code development that runs on a virtual machine or may provide a combination thereof. The IDE 106 may provide a managed code development environment using a framework such as Java SE, .NET, Node.js, Python Frameworks such as Django, Flask, etc., Ruby on Rails, PHP Frameworks such as Laravel, Symfony, etc., React, and others. It should be noted that this operating environment embodiment is not constrained to providing the source code development services through an IDE and that other tools may be utilized instead, such as a stand-alone source code editor and the like.

A user can create and/or edit the source code files 415 according to known software programming techniques and the specific logical and syntactical rules associated with a particular source language via a user interface 822 and a source code editor 110 in the IDE 106. Thereafter, the source code files 415 can be compiled via a compiler 824, such as a front end or language compiler. During this compilation process, the front-end compiler 824 generates data structures representing the syntactic structure and semantic model of the source code.

Project server 120 may be any type of electronic device, including without limitation those detailed for user terminals 104. A project server may be configured utilizing a cloud service. A project server 120 may include one or more processors 850, a communication interface 852, one or more storage devices 854, one or more input/output devices 856, and a memory 860. A processor 850 may be any commercially available or customized processor and may include multi-processor architectures. The communication interface 852 facilitates wired or wireless communications between the computing devices such as user terminals 104 and other devices. The components of a project server 120 are communicatively coupled via one or more buses 858.

A storage device 854 may be a computer-readable medium that does not contain propagating signals, such as modulated data signals transmitted through a carrier wave. Examples of a storage device 854 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 854 in the project server 120. The input/output devices 856 may include a keyboard, mouse, pen, voice input device, touch input device, display, speakers, printers, etc., and any combination thereof.

A memory 860 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. A memory 860 may also include one or more external storage devices or remotely located storage devices.

The memory 860 may contain instructions, components, and data. Various of these components and data are detailed above with respect to FIG. 1 and FIG. 4. The memory 860 may include an operating system 870, one or more source code files 125, and other applications and data 888. Permission validator 460 works with permission mapper 462 and project team structures and roles 466, which comprises users database 468 and groups & roles database 470. Project server 120 also comprises source code masker 464, abstract syntax tree 140, permissions 142, operations 144, workflows 146, and code templates 148. Active session manager 130 maintains and synchronizes sessions 1-N 430a-n via session user association 450 and session state synchronizer 455.

The user terminals 104 and project server 120 may be communicatively coupled via network 840. The network 840 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 840 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative, and not limiting. Therefore, the spirit and scope of the appended claims should not be limited to the foregoing description. In U.S. applications, only those claims specifically reciting “means for” or “step for” should be construed in the manner required under 35 U.S.C. § 112(f).

What is claimed is:

1. A method comprising:
generating a data structure that tracks a syntax structure and semantic model of a source code program comprising a plurality of constructs, the data structure comprising:
a record for each of a plurality of constructs; and
a permission requirement for one of the plurality of constructs referenced from the record for that construct;
setting a permission for a user identification associated with a user;
encountering an event associated with the user identification operating on the source code program operable with a portion of the source code program comprising the construct;
accessing in the data structure the record for the construct;
accessing the permission requirement referenced from the construct; and
determining whether the permission for the user identification satisfies the permission requirement.

2. The method of claim 1, further comprising:
allowing a source code editing activity associated with the permission when the permission requirement is satisfied; and
preventing the source code editing activity when the permission requirement is not satisfied.

3. The method of claim 2, wherein the source code editing activity comprises adding to the source code program.

4. The method of claim 2, wherein the source code editing activity comprises viewing a portion of the source code.

5. The method of claim 2, wherein the source code editing activity comprises rejecting a source code auto-suggestion.

6. The method of claim 2, wherein the source code editing activity comprises editing a source code auto-suggestion.

7. The method of claim 2, wherein the source code editing activity comprises editing a source code template for use in source code auto-suggestion.

8. The method of claim 1, wherein the permission requirement for one of the plurality of constructs is indicated by a permission requirement directive keyword in the source code program.

9. The method of claim 8, wherein permission requirement directive keyword indicates the portion of source code is immutable.

10. The method of claim 8, wherein permission requirement directive keyword indicates the portion of source code is invisible.

11. The method of claim 1, wherein the permission requirement for one of the plurality of constructs is indicated by a type definition being one of a predetermined class.

12. The method of claim 1, further comprising setting additional permissions for an additional plurality of user identifications, each permission corresponding to one of a plurality of operations for operating on the source code program.

13. The method of claim 1, further comprising accessing a workflow defining instructions for an integrated design environment to carry out responsive to the permission satisfying the permission requirement.

14. The method of claim 13, wherein the workflow comprises logging a source code editing activity.

15. The method of claim 13, wherein the workflow comprises generating an indication for sending to a user of the integrated design environment responsive to a source code editing activity.

16. The method of claim 15, wherein the indication is a message.

17. A system comprising:
one or more processors coupled to a memory; and
one or more programs, wherein the one or more programs are stored in the memory and configured to be executed by the one or more processors, the one or more programs including instructions that:
generate a data structure that tracks a syntax structure and semantic model of a source code program comprising a plurality of constructs, the data structure comprising:
a record for each of a plurality of constructs; and
a permission requirement for one of the plurality of constructs referenced from the record for that construct;
set a permission for a user identification associated with a user;
encounter an event associated with the user identification operating on the source code program operable with a portion of the source code program comprising the construct;
access in the data structure the record for the construct;
access the permission requirement referenced from the construct; and
determine whether the permission for the user identification satisfies the permission requirement.

18. A method, operable by a first user and a second user within an Integrated Development Environment (IDE), the first user associated with a first user identification, the second user associated with a second user identification, the method comprising:
encountering an IDE operation initiated by the first user;
determining whether the IDE operation requires an IDE operation permission level;
responsive to the IDE operation requiring an IDE operation permission level, determining whether a first permission setting associated with the first user identification allows the IDE operation; and
responsive to the first permission setting not allowing the IDE operation, sending an indication to the second user requesting the first permission setting to be altered to allow the IDE operation, the second user identification associated with a second permission setting, the second permission setting indicating the second user has permission to alter the first permission setting.

19. The method of claim 18, wherein the indication is a message.

20. The method of claim 18, further comprising:
determining whether a third permission setting associated with the first user identification allows the first user to alter the first permission; and
responsive to the third permission setting allowing the first user to alter the first permission:
altering the first permission setting to allow the IDE operation, bypassing the indication-sending step; and
allowing the IDE operation to proceed.

21. The method of claim 18, further comprising:
receiving a response to the indication sent to the second user;
allowing the IDE operation to proceed responsive to the response altering the first permission to allow the IDE operation; and
disallowing the IDE operation responsive to the response not altering the first permission.

22. The method of claim 18, further comprising setting an indicator in a dashboard associated with the first user identification indicating that the permission altering request is pending.

23. A system comprising:
one or more processors coupled to a memory; and
one or more programs, wherein the one or more programs are stored in the memory and configured to be executed by the one or more processors, the one or more programs including instructions that:
encounter an Integrated Development Environment (IDE) operation initiated by a first user;
determine whether the IDE operation requires an IDE operation permission level;
responsive to the IDE operation requiring an IDE operation permission level, determine whether a first permission setting for a first user identification associated with the first user allows the IDE operation; and
responsive to the first permission setting not allowing the IDE operation, send an indication to a second user requesting the first permission setting to be altered to allow the IDE operation, the second user having a second user identification associated with a second permission setting, the second permission setting indicating the second user has permission to alter the first permission setting.
